(19) United States
(12) Patent Application Publication
(10) Pub. No.: US 2026/0088752 A1
(43) Pub. Date: Mar. 26, 2026

(54) INTEGRATED SOLAR TRACKER CONTROLLER AND DC/DC CONVERTER

(71) Applicant: Nextracker LLC, Fremont, CA (US)

(72) Inventors: Alexander W. AU, Oakland, CA (US); Niloofar Torabi, Redwood City, CA (US); Jason Sean Henry, Palo Alto, CA (US)

(21) Appl. No.: 19/338,166

(22) Filed: Sep. 24, 2025

Related U.S. Application Data
(60) Provisional application No. 63/698,913, filed on Sep. 25, 2024.

(51) Int. Cl. H02S 20/32; H02S 40/32; H02S 40/38; H02S 40/42

(52) U.S. Cl. CPC H02S 20/32; H02S 40/32; H02S 40/38; H02S 40/42

(57) ABSTRACT

An integrated system for solar tracking and DC/DC conversion can include a housing with heat sink fins, a DC power supply configured to receive DC power from one or more solar panels and supply DC power to internal components, and a self-powered controller electrically connected to the DC power supply. The self-powered controller outputs control signals to one or more motors to orient the solar panels. The system further includes a plurality of configurable power blocks that are selectively operable as DC/DC converters to perform maximum power point tracking or as DC/AC converters. A battery module is detachably couplable to the housing by a connector and is electrically connected to the DC power supply to provide backup power. The housing can be formed of a heat-conducting material to enable passive cooling. The battery module can include a seal to prevent ingress of debris and fluids.

### RELATED APPLICATIONS

This application claims priority to U.S. Provisional Ser. No. 63/698,913 , filed on Sep. 25, 2024, the entire contents of which are hereby incorporated by reference.

### TECHNICAL FIELD

This disclosure generally relates to electrical power converters and inverters.

### BACKGROUND

Solar energy is an increasingly important renewable, non-polluting energy source. For solar energy, photovoltaic (PV) panels arranged in an array or string typically provide the means to convert solar energy into electrical energy. In operating photovoltaic (PV) arrays, maximum power point tracking (MPPT) is generally used to automatically determine a voltage or current at which the PV array should operate to generate a maximum power output for a particular temperature and solar irradiance. DC/DC power converters are used to perform MPPT on individual PV panels, strings of PV panels, and other configurations of PV panels. Including DC/DC power converters on individual PV panels may increase performance but at an increased cost while including DC/DC power converters on strings of PV panels may decrease cost but with less of an increase in performance.

Static PV panels are unable to convert energy at their full potential due to the fact that the sun is often at an angle that is not optimum for the solar cells to receive solar energy. Accordingly, various types of solar tracking mechanisms have been developed to increase performance. Solar tracking mechanisms often include a motor for moving PV panels and a controller for controlling the motor to position the PV panels in an optimum orientation. Powering and controlling solar tracking mechanisms can be complex and involve many components.

### SUMMARY

In general, this disclosure describes an integrated solar tracker controller and DC/DC power converter. The integrated solar tracker controller and DC/DC power converter can be used for a string of solar panels and enable both control of the orientation of the string of solar panels and enable MPPT for the string of solar panels. The integrated solar tracker controller and DC/DC power converter combines the functionality of a self-powered solar tracker controller and a maximum power point tracking system within a single housing. Combining a solar tracker controller and DC/DC power converter in a single housing can decrease a number of devices, communication between the devices, and can simplify installation.

The details of one or more examples are set forth in the accompanying drawings and the description below. Other features, objects, and advantages will be apparent from the description and drawings, and from the enumerated embodiments.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1A is a perspective view of an example integrated solar tracker controller and DC/DC converter according to an aspect of the present disclosure.

FIG. 1B is a sectional view of the example integrated solar tracker controller and DC/DC converter of FIG. 1A.

FIG. 2 is a block diagram of an example solar tracker controller portion of an integrated solar tracker controller and DC/DC converter according to an aspect of the present disclosure.

FIG. 3 is a perspective cut view of an example integrated solar tracker controller and DC/DC converter with top portion removed according to an aspect of the present disclosure.

FIG. 4 is a perspective view of a battery portion of an example integrated solar tracker controller and DC/DC converter according to an aspect of the present disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

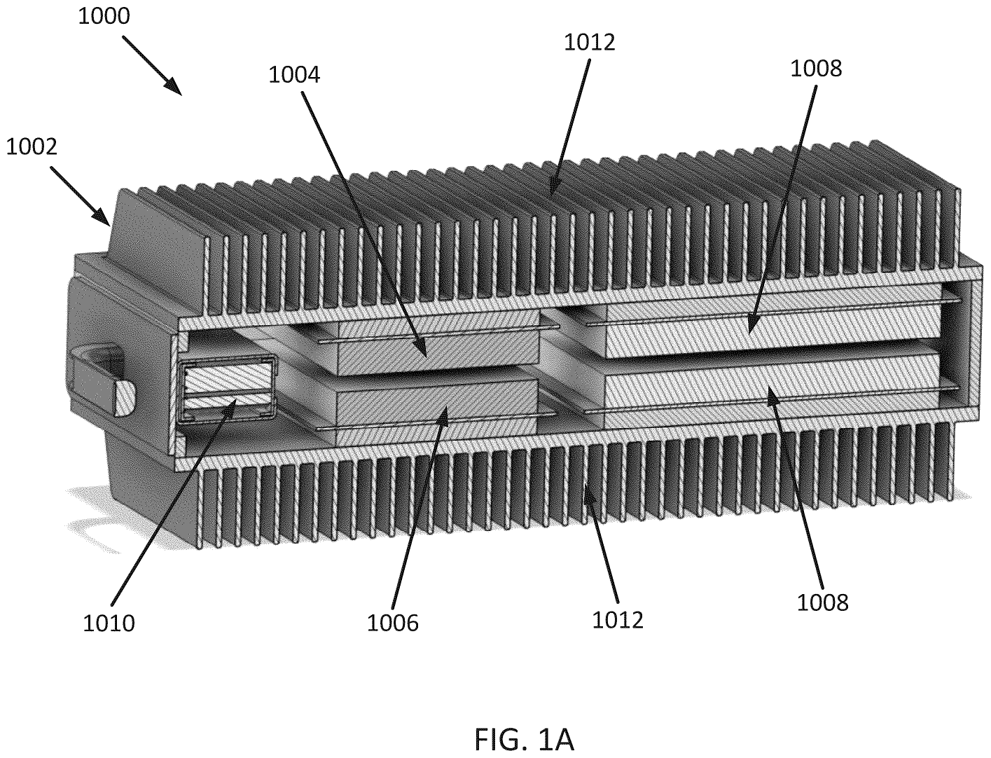

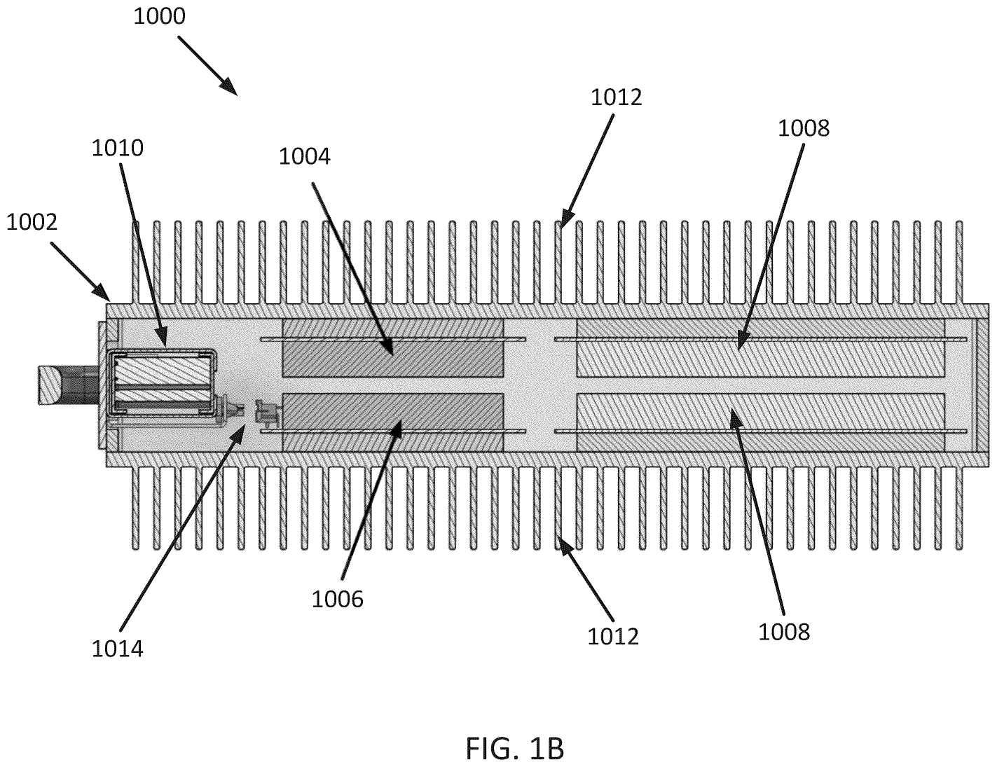

Referring to both FIG. 1A and FIG. 1B, FIG. 1A is a perspective view of an example integrated solar tracker controller and DC/DC converter 1000 according to an aspect of the present disclosure while FIG. 1B is a sectional view of the example integrated solar tracker controller and DC/DC converter 1000 of FIG. 1A. Throughout this disclosure, the term “integrated solar tracker controller and DC/DC converter” is also referred to as “optimizer and tracker controller”. The optimizer and tracker controller 1000 includes a housing 1002 that houses a variety of electrical components. The electrical components include a DC power supply 1004, a self-powered controller 1006, a pair of configurable power blocks 1008, and a battery module 1010. The housing 1002 also includes a plurality of heat sink fins 1012 on both a top and bottom of the housing 1002. In some examples, the housing 1002 includes a battery connection 1014 that electrically connects the battery module 1010 with the DC power supply 1004.

The optimizer and tracker controller 1000 also includes electrical connections that are used to electrically connect the optimizer and tracker controller 1000 to parts of a solar system. For example, the optimizer and tracker controller 1000 can be electrically connected to one or more solar trackers, which include one or more solar panels and one or more motors for orienting the one or more solar trackers. The optimizer and tracker controller 1000 can also be in wireless communication with parts of a solar system, such as other optimizer and tracker controllers, network control units (NCUs), and other controllers (e.g., system-level controllers).

Because the optimizer and tracker controller 1000 is electrically connected to one or more solar panels, the optimizer and tracker controller 1000 can receive power from the one or more solar panels. To utilize power provided by the one or more solar panels, the optimizer and tracker controller 1000 includes the DC power supply 1004. The DC power supply 1004 comprises circuitry, including a DC/DC converter, which enables the DC power supply 1004 to receive DC power from one or more connected solar panels, convert the DC power as needed, and provide power to components within the optimizer and tracker controller 1000. For example, the DC power supply 1004 can provide power to electrical components of the self-powered controller 1006, one or more motors used to control the orientation of connected solar trackers, the configurable power blocks 1008, the battery module 1010, and various communication circuitry (e.g., for wireless communications). In some examples, in addition to providing power to the battery module 1010, the DC power supply 1004 can also receive power from the battery module 1010. For instance, the battery module 1010 can provide backup power to the electrical components of the optimizer and tracker controller 1000 through the DC power supply (e.g., to convert the battery voltage to voltages usable by the other electrical components). Alternatively, in some examples, the battery module 1010 can provide backup power directly to the electrical components of the optimizer and tracker controller 1000.

A person having ordinary skill in the art will appreciate that the DC power supply 1004 can be used to supply DC power to any components of the optimizer and tracker controller 1000 and that this disclosure is not limited to the example listed components. In some examples, in addition to or in lieu of receiving power from one or more connected solar panels, the DC power supply 1004 can receive power from an external source, such as externally connected batteries (e.g., via a common DC bus) and external AC power (e.g., from an AC grid). In some such embodiments, the DC power supply 1004 includes an AC/DC converter (i.e., inverter).

The optimizer and tracker controller 1000 also includes the self-powered controller 1006. The self-powered controller 1006 is configured to electrically connect to a motor that is configured to orient a solar tracker comprising solar panels. The self-powered controller 1006 can be described as a controller that does not connect to external wires or an external power source (e.g., power grid). For instance, the self-powered controller 1006 can be powered by one or more connected solar panels, to which it controls the orientation (e.g., not an external power source). In some examples, the self-powered controller 1006 is electrically connected to the DC power supply 1004, which is electrically connected to one or more solar panels. Accordingly, the self-powered controller 1006 can receive power from one or more solar panels via the DC power supply 1004. Additionally or alternatively, in some examples, the self-powered controller 1006 is electrically connected to one or more solar panels directly. Accordingly, the self-powered controller 1006 can receive power from the one or more electrically connected solar panels directly. In some embodiments, the self-powered controller 1006 includes a DC/DC converter, which can be used to convert power from one or more electrically connected solar panels.

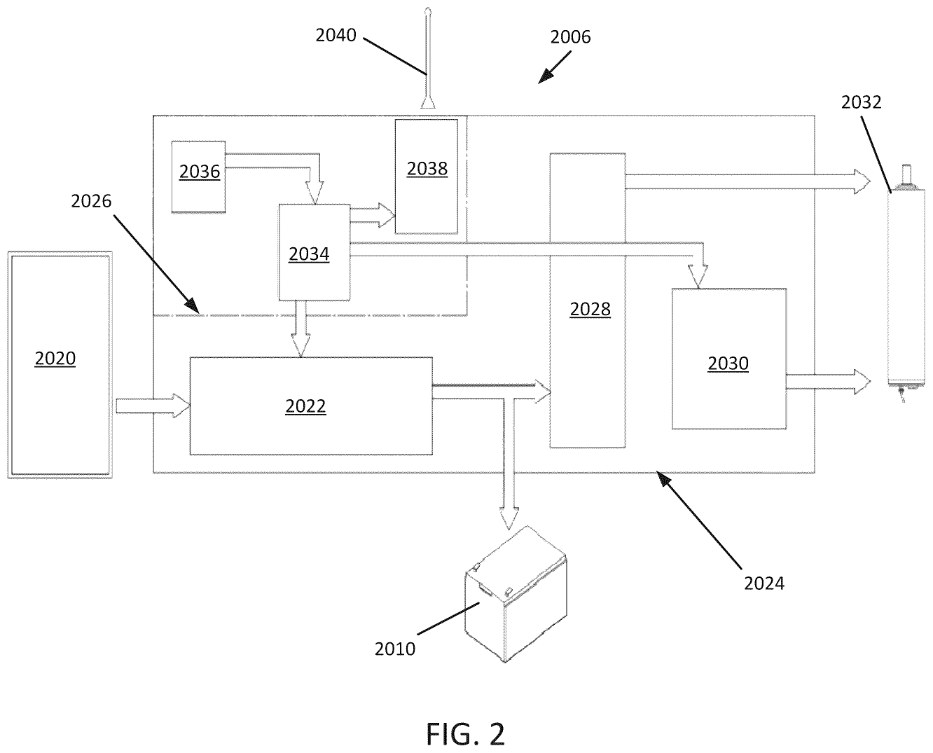

Referring to FIG. 2, FIG. 2 is a block diagram of an example solar tracker controller 2006 portion of an integrated solar tracker controller and DC/DC converter according to an aspect of the present disclosure. The solar tracker controller 2006 can also be referred to as a self-powered controller (e.g., self-powered controller 1006). In the illustrated embodiment, the self-powered controller 2006 includes a power region 2024 that generally includes power components/connections and a control region 2026 that generally includes control (e.g. data) components/connections. The self-powered controller 2006 is electrically connected to one or more solar panels 2020 and to one or more motors 2032 for controlling an orientation of one or more solar panels coupled to the one or more motors (e.g., solar trackers). In some examples, the one or more solar panels having their orientation controlled are the same solar panels electrically connected to the self-powered controller, though they need not be.

In the power region 2024, the self-powered controller 2006 includes a DC/DC converter 2022, a boost converter 2028, and a motor drive 2030. In the control region 2026, the self-powered controller 2006 includes a controller unit 2034 that includes various inputs and outputs. In operation, the self-powered controller 2006 can receive power from one or more solar panels 2020 and can use the power from the one or more solar panels to control operation of the one or more motors 2032. As the one or more motors 2032 are coupled to one or more solar panels (e.g., solar trackers), the self-powered controller 2006 can control an orientation of the one or more solar panels (e.g., solar trackers).

Referring to the power region 2024, in some examples, the DC/DC converter 2022 is configured to receive DC power directly from a solar panel 2020, or solar panels, rather than from a DC power supply (e.g., DC power supply 1004). To use the power generated by the solar panel 2020, the self-powered controller 2006 can include a DC/DC converter 2022 electrically connected to the solar panel 2020. The DC/DC converter 2022 can convert DC power generated by the solar panel 2020 into DC power useable by the other electronics of the self-powered controller 2006, such as the motor 2032.

The DC/DC converter 2022 can be electrically connected to the battery 2010 and in some examples, the DC/DC converter 2022 is part of a battery charger, which can include further components. For instance, the battery charger can include sensors (e.g., voltage, current, and temperature sensors) and a controller for controlling the charging and discharging of the battery 2010. The battery 2010 is illustrated as being external to the self-powered controller 2006 and in some examples, can be analogous to the battery module 1010 of FIG. 1A/B. The battery 2010 can be used as backup power for the various components of the self-powered controller 2006. In some examples, the battery 2010 is used to provide power to various components of the self-powered controller 2006 when there is not sufficient solar power generated by the solar panel 2020.

Referring to the control region 2026, the controller unit 2034 can include one or more inputs coupled to one or more of a motor current, a motor voltage, a solar panel current sensor, a solar panel voltage sensor, a battery current sensor, a battery voltage sensor, and a battery temperature sensor. The controller unit 2034 also includes one or more outputs (e.g., control signals) coupled to the DC/DC converter 2022 (or battery charger), the boost converter 2028, and the motor drive 2030. With such connections, the controller unit 2034 can control aspects of the self-powered controller 2006 including, but not limited to, charging/discharging of the battery and rotation of the motor 2032 connected to the motor drive 2030. The boost converter 2028 can be used to increase a voltage to power the motor 2032.

In some examples, the self-powered controller 2006 includes an inclinometer 2036 which can provide an output signal to the controller unit 2034. The inclinometer device can be configured to measure angles of slope (or tilt), elevation, and/or depression of solar panels with respect to gravity. Accordingly, the controller unit 2034 can use such information in its control of the motor drive 2030 and motor 2032. In some examples, rather than an inclinometer, the device can be a tilt meter, tilt indicator, slope alert, slope gauge, gradient meter, gradiometer, level gauge, level meter, declinometer, and pitch & roll indicator.

The control region 2026 can also include a wireless module 2038 coupled to an antenna 2040 for communicating wirelessly to and from the controller unit 2034. The wireless module 2038 can use any wireless protocol and is not limited to any singular wireless protocol to transmit and receive wireless signals. The wireless module 2038 is in electric communication with the controller unit 2034 and accordingly, the controller unit 2034 can transmit and receive wireless communications. For instance, a solar power plant controller (e.g., NCU) can transmit information relating to a desired orientation of solar panels to the controller unit 2034 via the wireless module 2038. In such an example, the controller unit 2034 can subsequently cause the motor drive 2030 to rotate the motor 2032 to ensure the solar panels are oriented to the desired orientation. The controller unit 2034 could then transmit back to the solar power plant controller when the solar panels are oriented in the desired orientation.

In some examples, the controller unit 2034 is also in communication with other parts of an optimizer and tracker controller (e.g., 1000 of FIG. 1A/B). For instance, the controller unit 2034 can communicate with a DC power supply (e.g., 1004), one or more configurable power blocks (e.g., 1008), and/or a battery module (e.g., 1010). In some such examples, the controller unit 2034 can receive and transmit data relating to the other parts of the optimizer and tracker controller to and from a solar power plant controller via the wireless module 2038. For instance, the controller unit 2034 can receive and transmit data relating to the DC power supply 1004, the battery module 1010, and/or the configurable power blocks 1008. Additionally or alternatively, in some examples, the optimizer and tracker controller can include wireless module separate from the wireless module 2038 to receive and transmit data from the optimizer and tracker controller. Such a wireless module could communicate with the wireless module 2038 or replace the wireless module 2038.

The self-powered controller 2006 can be used in conjunction with any number of solar panels/solar trackers. For instance, in some examples, the self-powered controller 2006 is used at an individual tracker level, whereby an individual solar tracker, having one or more solar panels, orients all the panels to a common orientation to track the sun. The individual tracker level can sometimes refer to a single motor that controls a number of solar panels. The self-powered controller 2006 can also be disposed on a portion of a solar tracker or solar panel. For instance, the self-powered controller 2006 can be located on a torque tube (e.g., for rows of solar panels connected together via the torque tube), on the back of a solar panel, on a pier, or generally proximate a solar tracker.

Referring back to FIGS. 1A and 1B, the optimizer and tracker controller 1000 includes configurable power blocks 1008. While two configurable power blocks 1008 are illustrated, any number of power blocks (e.g., one or more) can be included in the optimizer and tracker controller 1000. The configurable power blocks 1008 can be in electric communication with one or more of the DC power supply 1004, the self-powered controller 1006, one or more solar panels, each other, and/or a DC bus. In some examples, the configurable power blocks 1008 are electrically connected to each other in parallel to increase their energy capacity. For instance, each configurable power block 1008 can have a power capacity of approximately 50 kW with both connected in parallel having a capacity of 100 kW. In general, the configurable power blocks 1008 include components that enable the configurable power blocks 1008 to act as DC/DC converters or DC/AC converters (e.g., inverters). In some embodiments, the configurable power blocks 1008 can include components that enable the configurable power blocks 1008 to transition from acting as DC/DC converters to DC/AC converters and from acting as DC/AC converters to DC/DC converters.

When configured to act as DC/DC converters, the configurable power blocks 1008 can perform maximum power point tracking (MPPT) for any connected solar panels. For instance, a string of solar panels can be electrically connected to one or both of the configurable power blocks 1008 with the one or both of the configurable power blocks 1008 ensuring the string of solar panels operates at a maximum power point. The type of MPPT performed is not limited. For instance, the configurable power blocks 1008 can use a power droop algorithm to enable local control of power output by connected solar panels based on an external load. In some examples, the configurable power blocks 1008 can act as bi-directional DC/DC converters. For instance, the configurable power blocks 1008 can be configured to act as bi-directional boost converters to increase an input voltage to a higher output voltage. In some such examples, an internal resistance of the bi-directional DC/DC converters can maintain a relatively equal current sharing between connected solar panels (e.g., as part of a string of solar panels).

In some examples, the configurable power blocks 1008 include a controller configured to control aspects of the configurable power blocks 1008 such as their configuration (e.g., DC/DC converter vs. DC/AC converter) and MPPT control. Additionally or alternatively, in some examples, the self-powered controller 1006 can control aspects of the configurable power blocks 1008. In some such examples, the controller unit 2034 can control the configurable power blocks 1008.

In some examples, one or more configurable power blocks can operate differently than another one or more configurable power blocks of the optimizer and tracker controller 1000. For instance, in the illustrated embodiment of FIG. 1A/B, one of the configurable power blocks 1008 can act as a DC/DC converter performing MPPT while a second of the configurable power blocks, which is connected to an output of the DC/DC converter performing MPPT, can act as a DC/DC converter to increase the output voltage to a desired level. In another example, one of the configurable power blocks can act as a DC/DC converter performing MPPT while the other configurable power block, which is connected to an output of the DC/DC converter performing MPPT, can act as a DC/AC converter to convert the DC input power to AC output power.

While various examples and aspects of the configurable power blocks 1008 have been described, further details of the configurable power blocks 1008 are described in co-pending U.S. provisional patent application No. 63/603,107 filed Nov. 27, 2023, and co-pending U.S. provisional patent application No. 63/676,667 filed Jul. 29, 2024, the entire contents of each of which are incorporated by reference herein.

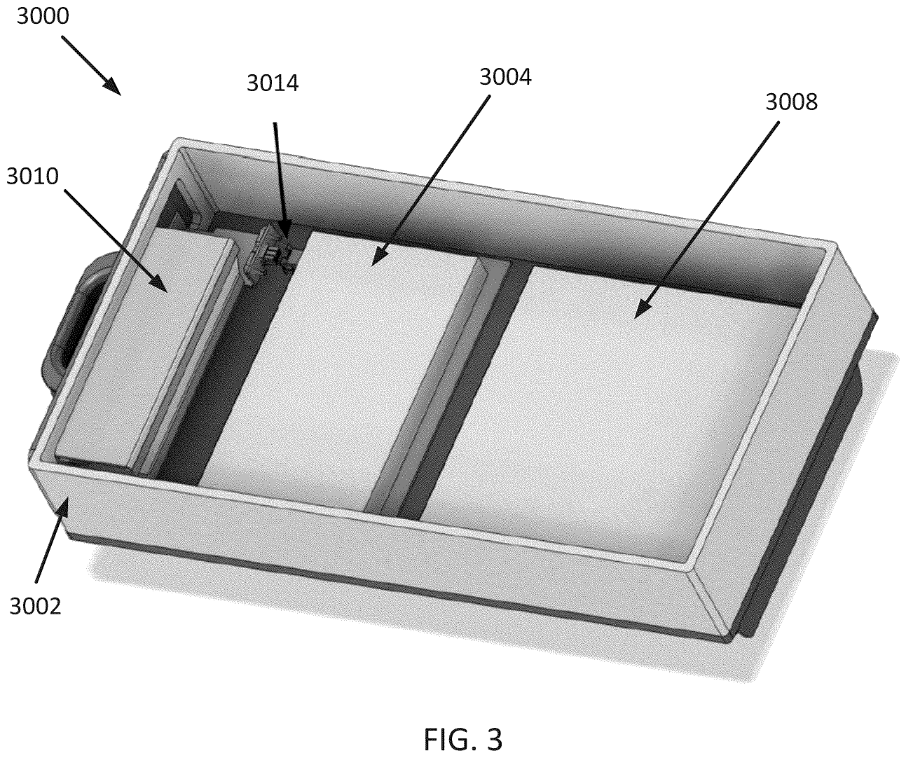

Referring to FIG. 3, FIG. 3 is a perspective cut view of an example integrated solar tracker controller and DC/DC converter 3000 (also referred to as optimizer and tracker controller 3000) with a top portion removed according to an aspect of the present disclosure. The optimizer and tracker controller 3000 includes a housing 3002, a DC power supply 3004, a configurable power block 3008, a battery module 3010, and a battery connection 3014. While not visible, the optimizer and tracker controller 3000 also includes a self-powered controller and another configurable power block. The battery module 3010 is electrically connected to the DC power supply 3004 and can be coupled with the housing 3002 of the optimizer and tracker controller 3000 and/or coupled with the DC power supply 3004.

The battery connection 3014 electrically connects the battery module 3010 with the DC power supply 3004. In the illustrated embodiment, the battery connection 3014 can comprise a “blind mate” connection. The “blind mate” connection can include a connection portion that is part of the battery module 3010 and a connection portion that is part of the DC power supply 3004. In operation, the “blind mate” connection can enable a user to, after performing any alignment of the battery module 3010 with the optimizer and tracker controller 3000, connect the battery module 3010 with the DC power supply 3004 without needing to visually align the connection itself. For example, the battery module 3010 can be removed and replaced with another battery module that can be slide into place and make electrical connection with the DC power supply through the battery connection 3014. In some examples, the battery connection 3014 includes pins and corresponding sockets for electrically connecting a battery module 3010 with the DC power supply. In some examples, the battery connection 3014 includes clips, detents, or other frictional engagements to prevent disconnection and removal of the battery module 3010 without additional actions or additional removal force.

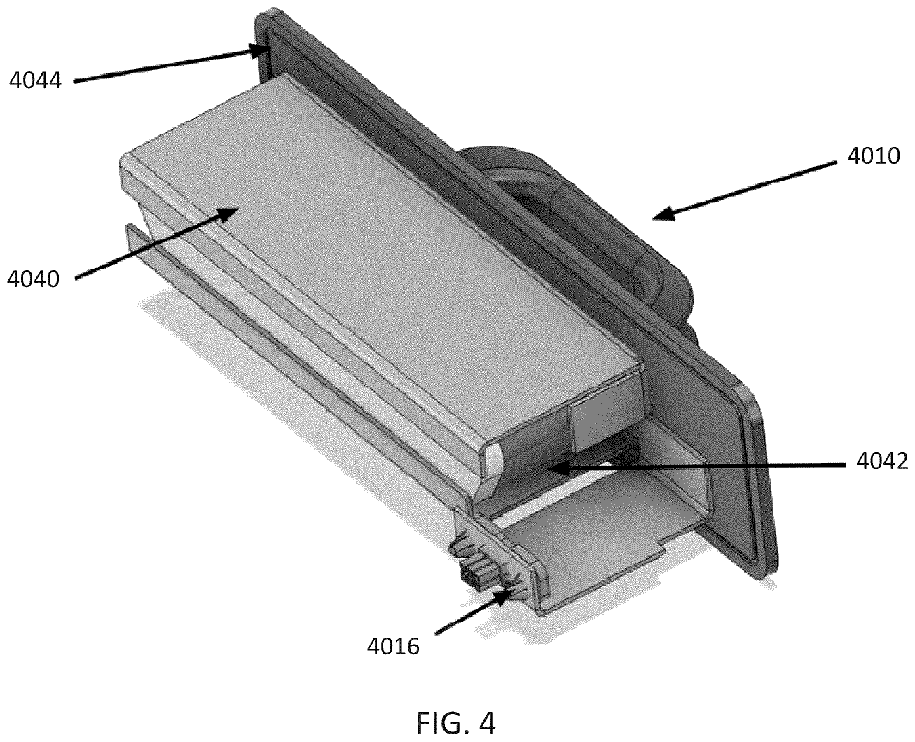

Referring to FIG. 4, FIG. 4 is a perspective view of a battery module 4010 of an example integrated solar tracker controller and DC/DC converter according to an aspect of the present disclosure. The battery module 4010 can include a battery housing 4040 that encases a plurality of battery cells 4042. The battery module 4010 can also include a portion of a “blind mate” connection. In particular, the battery module 4010 includes a floating blind mate interface connector 4016 which can be used to connect the battery module 4010 with a DC power supply (e.g., DC power supply 3004). The battery module 4010 can also include a seal 4044. The seal 4044 can be on an interior of the battery module 4010 surrounding the battery housing and can prevent dirt, dust, debris, fluids, etc. from entering an optimizer and tracker controller. For instance, as illustrated in FIG. 3, the battery module 3010 is coupled with and electrically connected to the optimizer and tracker controller 3000. The opening of the optimizer and tracker controller into which the battery module 3010 is inserted is surrounded by a faceplate of the battery module 3010 which, as seen in FIG. 4, can include a seal 4044. The seal can accordingly prevent debris from entering the opening of the optimizer and tracker controller.

Advantages of the optimizer and tracker controller disclosed herein can include reduced installation time and reduced cost due to including a self-powered solar tracker controller and a DC/DC converter for performing MPPT. Further, combining the self-powered solar tracker controller and DC/DC converter for performing MPPT can be advantageous as data, such as solar panel voltage, current, power, motor voltage, current, rotation, battery voltage, current, and other data can be easily transmitted between the self-powered solar tracker controller and DC/DC converter (e.g., via internal wired connections). Additionally, because the housing 1002 includes the heat sink fins 1012 and because the heat generating electrical components (e.g., DC power supply 1004, configurable power blocks 1008) of the system are in contact with the housing 1002, which can be made from a heat-conducting material, the entire optimizer and tracker controller can be passively cooled. Passive cooling can reduce complexity and increase reliability (e.g., due to fewer moving parts). Moreover, because the housing 1002 includes both a self-powered solar tracker controller and a DC/DC converter for performing MPPT, electrical connections between these electrical components are shorter, more efficient, and can be reduced relative to a system having a separate solar tracker controller and DC/DC converter for performing MPPT. Integrating the DC power supply 1004 into the optimizer and tracker controller also provides an advantage as DC power can be provided directly to components within the optimizer and tracker controller from connected solar panel(s) and/or a connected battery.

Further details of a self-powered controller (e.g., 1000) can be found in U.S. Pat. No. 11,967,921 filed Aug. 9, 2022, the entire contents of which are incorporated by reference herein.

It is understood that the examples and embodiments described herein are for illustrative purposes only and that various modifications or changes in light thereof will be suggested to persons skilled in the art and are to be included within the spirit and purview of this application and scope of the appended claims.

1. A system for solar tracking and DC/DC conversion, comprising:
a housing including a plurality of heat sink fins on exterior surfaces;
a DC power supply disposed within the housing, the DC power supply having circuitry configured to receive DC power from one or more solar panels and to supply DC power to components within the housing;
a self-powered controller disposed within the housing and electrically connected to the DC power supply, the self-powered controller powered by the one or more solar panels via the DC power supply and configured to output control signals to one or more motors to orient the one or more solar panels;
a plurality of configurable power blocks disposed within the housing and electrically connected to the DC power supply, each configurable power block selectively operable as a DC/DC converter to perform maximum power point tracking on one or more solar panels and as a DC/AC converter; and
a battery module detachably couplable to the housing by a blind-mate connector and electrically connected to the DC power supply to provide backup power to the components within the housing.

2. The system of claim 1, wherein the housing is formed of a heat-conducting material to enable passive cooling of internal components.

3. The system of claim 2, wherein the plurality of heat sink fins are disposed on both the top and bottom exterior surfaces of the housing.

4. The system of claim 1, wherein the DC power supply further comprises an AC/DC converter configured to receive AC power from an external source and convert the AC power to DC power.

5. The system of claim 1, wherein the self-powered controller comprises second a DC/DC converter electrically connected to the one or more solar panels to convert DC power generated by the one or more solar panels into a voltage usable by one or more internal components.

6. The system of claim 5, wherein the self-powered controller further comprises a boost converter electrically coupling the DC power supply to the one or more motors, the boost converter configured to increase a voltage to power the one or more motors.

7. The system of claim 5, wherein the self-powered controller further comprises an inclinometer configured to measure a tilt angle of the one or more solar panels, the inclinometer providing a corresponding signal to the self-powered controller.

8. The system of claim 5, wherein the self-powered controller further comprises a wireless communication module and an antenna configured to exchange data with a network control unit.

9. The system of claim 1, wherein the plurality of configurable power blocks comprises at least two power blocks connected in parallel to share a common DC bus.

10. The system of claim 9, wherein each configurable power block is bi-directional and configurable to perform both boost and buck DC/DC conversion.

11. The system of claim 9, wherein the plurality of configurable power blocks comprises a first power block configured to perform maximum power point tracking on the one or more solar panels and a second power block configured to convert DC power to AC power.

12. The system of claim 1, wherein the battery module comprises a battery housing enclosing a plurality of battery cells and a seal arranged to prevent ingress of debris and fluids into the housing when the battery module is coupled to the housing.

13. The system of claim 12, wherein the blind-mate connector comprises a floating interface connector including pins and corresponding sockets configured for tool-less coupling of the battery module to the housing.

14. The system of claim 12, wherein the battery module is hot-swappable such that replacement of the battery module does not interrupt power to the self-powered controller.

15. The system of claim 13, wherein the seal is positioned on an interior faceplate of the battery module to prevent debris from entering the housing during installation or removal of the battery module.
